(19) United States
(12) Patent Application Publication
(10) Pub. No.: US 2009/0049951 A1
(43) Pub. Date: Feb. 26, 2009

(54) Assembled Crankshaft

(76) Inventors: Roger Budde, Chemnitz (DE); Erik Schneider, Chemnitz (DE)

Correspondence Address: COLLARD & ROE, P.C., 1077 NORTHERN BOULEVARD, ROSLYN, NY, 11576, US

(21) Appl. No.: 12/083,575

(22) PCT Filed: Nov. 10, 2006
(86) PCT No.: PCT/DE2006/001968

§ 371 Date: Apr. 15, 2008

(30) Foreign Application Priority Data
Nov. 23, 2005 (DE) 10 2005 056 183.7

(51) Int. Cl. F16C 3/06

(52) U.S. Cl. 74/595

(57) ABSTRACT

The invention relates to an assembled crankshaft composed of a plurality of crank cheeks which can be connected at one side to a main bearing journal and at the other side to a connecting rod bearing journal. The invention is based on the object of providing a crankshaft which is assembled from a plurality of individual parts, which is simple and quick to mount, which is characterized by a weight reduction and with which satisfactory lubrication of the bearing regions can be provided. According to the invention, the crank cheeks are provided at both sides with a ring-shaped groove for receiving the tubular main bearing journal and connecting rod bearing journal. In addition, the crank cheeks are provided with openings for a sleeve, which sleeves are in each case arranged within the main bearing journal and connecting rod bearing journal and are connected in a form-fitting and/or force-fitting manner to the crank cheeks.

The invention relates to an assembled crankshaft having the characteristics named in the preamble of claim 1.

It is generally known to assemble crankshafts from multiple individual parts. The crankshaft is formed from crank cheeks, main bearing journals and connecting rod bearing journals.

An assembled crankshaft is known from DE 195 36 349 C1, the individual parts of which consists of a crank cheek having tubular segments formed on on both sides, in each instance. The tubular segments of multiple crank cheeks are connected with one another by means of welding, in order to form the crankshaft. In this connection, the tubular segments connected with one another form the main bearing journal, on the one hand, and the connecting rod bearing journal, on the other hand. Oil openings are disposed in the crank cheeks for lubricating the bearing regions.

An assembled crankshaft is also known from DE 37 28 142 C2, which consists of individual crank cheeks having conically shaped tube pieces formed on. The connection surfaces of the tube pieces that are configured conically relative to one another are connected with one another by means of soldering, whereby the individual tube pieces also produce the main bearing journal and the connecting rod bearing journal.

An assembled crankshaft is known from JP 63-275809 A, which consists of crank cheeks disposed on both sides, with connecting rod bearing journals configured in tubular shape disposed between them. Ring grooves are disposed on the inside of the crank cheeks, to accommodate the connecting rod bearing journals configured in tubular shape. The individual parts are connected with one another by means of rivets that are passed through the two crank cheeks and through the connecting rod bearing journal. The main bearing journal is configured as a solid shaft that is inserted into an accommodation bore in the crank cheek. Attachment of the main bearing journal also takes place by means of riveting. In this connection, a rivet bolt is disposed on the face of the main bearing journal, which bolt is passed through the crank cheek and riveted in place there.

DE 102 58 759 A1 describes an assembled crankshaft consisting of crank cheeks and main bearing journals and connecting rod journals, configured in tubular shape. The crank cheeks are provided with openings for accommodating the main bearing journals and connecting rod bearing journals. The crank cheek is connected with the main bearing journals and connecting rod bearing journals by means of welding.

The relatively great effort required for assembling the crankshaft is a disadvantage of the prior art listed.

The invention is based on the task of creating a crankshaft assembled from multiple individual parts, which can be assembled easily and quickly, which is characterized by a weight reduction, and with which sufficient lubrication of the bearing regions can take place.

According to the invention, this task is accomplished by means of the characterizing features of claim 1.

The assembled crankshaft consists of crank cheeks having main bearing journals disposed on their outside, and connecting rod bearing journals disposed on their inside, whereby the main bearing journals and the connecting rod bearing journals are offset eccentrically from one another. According to the invention, the crank cheeks are equipped, on both sides, with a ring groove for accommodating the main bearing journals and connecting rod bearing journals, which are configured in tubular shape. Furthermore, the crank cheeks are provided with openings for a sleeve, which are disposed within the main bearing journals and connecting rod bearing journals, in each instance, and stand in connection with the crank cheeks with a shape fit and/or with a force fit.

The advantage of this configuration and arrangement according to the invention consists in the fact that the tubular main bearing journals and connecting rod bearing journals can be easily and precisely placed in the ring grooves during assembly of the crankshaft, and connected with the crank cheek there by means of soldering, gluing, welding, or the like, or by means of a friction fit. Furthermore, a weight-reducing configuration of the crankshaft results from the main bearing journals and connecting rod bearing journals configured in tubular shape, as well as from the openings disposed in the crank cheeks.

In advantageous manner, the sleeves disposed within the main bearing journals and the connecting rod bearing journals and standing in connection with the crank cheeks are configured as a hollow screw having a differential thread that stands in an effect connection with the two crank cheeks. By means of screwing the sleeves, which are provided with a differential thread, into the crank cheeks of the pre-assembled crankshaft, the result is achieved that the two crank cheeks of a crankshaft segment, which lie opposite one another, are braced relative to one another and thereby precise positioning of the assembled crankshaft takes place during assembly.

By means of the arrangement according to the invention, a ring channel is formed under the main bearing journal and the connecting rod bearing journal, in each instance, which channels are connected with one another by way of oil channels disposed in the crank cheek. The ring channels are connected with the oil exit openings disposed in the surfaces of the main bearing journals and connecting rod bearing journals, by way of bores, so that the bearing regions of the crankshaft can be sufficiently provided with lubricant oil during operation of the crankshaft.

Additional advantageous embodiments are described in the dependent claims; they are explained in the description, along with their effects.

The invention will be explained in greater detail below, using exemplary embodiments. The related drawings show:

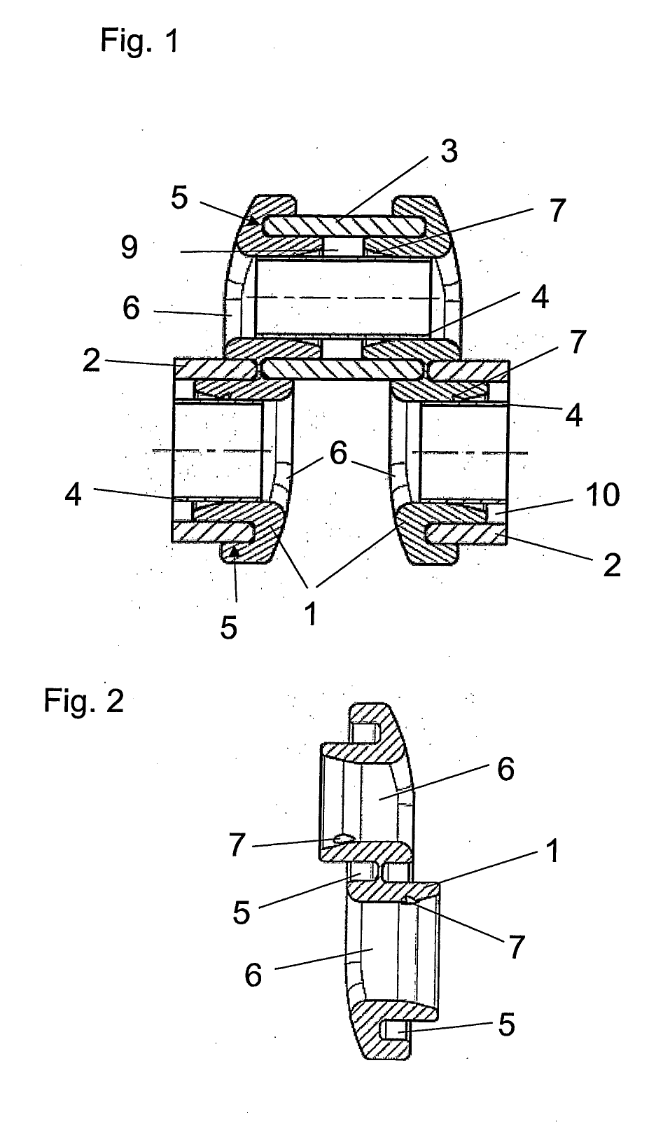

FIG. 1: a sectional representation of a crankshaft segment of the crankshaft according to the invention,

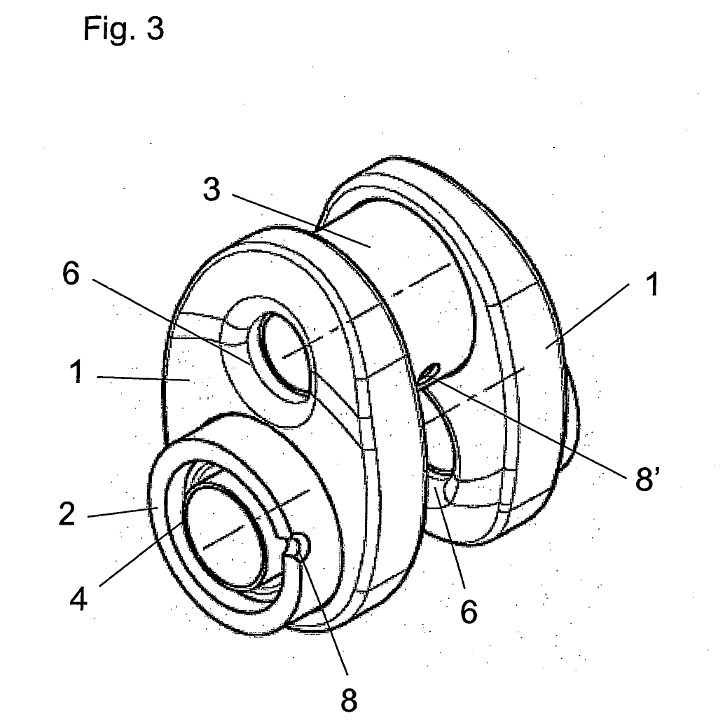

FIG. 2: a crank cheek according to the invention, in section, as a detail,

FIG. 3: a crankshaft segment in a perspective representation.

FIG. 1 shows a crankshaft segment of a crankshaft composed of multiple crankshaft segments. A crankshaft segment consists of the connecting rod bearing journal 3 disposed between two crank cheeks 1, and the main bearing journal 2 disposed on the opposite side of the crank cheeks 1 and spaced apart from the connecting rod bearing journal 3. In accordance with the structure of the crankshaft, the main bearing journals 2 are connected with an additional crank cheek 1, or the main bearing journals 2 are configured as end elements.

The crank cheeks 1, which can be a cast part, a sintered part, or a forged part, are provided, on both sides, with a ring groove 5, for accommodating the main bearing journal 2 configured in tubular shape, and the connecting rod bearing journal 3. In FIG. 2, the crank cheek 1 according to the invention is shown in section, as a detail. The crank cheek 1 is provided with openings 6 for sleeves 4, which are disposed within the main bearing journals 2 and the connecting rod bearing journals 3, and stand in connection with the crank cheeks 1 with a shape fit and/or a force fit. The sleeves 4 are preferably configured as hollow screws having a differential thread, and stand in an effect connection with the two crank cheeks 1 that delimit the connecting rod bearing journal 3. In this connection, one part of the sleeve 4 has a lesser outside diameter having a greater thread pitch. The other part of the sleeve 4 has a greater diameter having a greater thread pitch. The bores of the openings 6 of the two crank cheeks 1 are accordingly equipped with different inside threads for accommodating the sleeve 4. The side of the sleeve 4 having the lesser outside diameter is passed through the larger opening 6 of the crank cheek 1. Afterwards, the thread situated on the sleeve 4 having the lesser diameter engages into the corresponding inside thread of the opposite crank cheek 1. Afterwards, the thread of the sleeve 4 having the greater diameter engages into the thread of the other crank cheek 1. By means of the different pitches, the sleeve 4 pulls the two crank cheeks 1 towards one another, so that the main bearing journals 2 and the connecting rod bearing journals 3, respectively, are pressed into the corresponding ring groove 5 in the crank cheeks 1. In addition, the tubular main bearing journals 2 and connecting rod bearing journals 3 inserted into the ring grooves 5 are soldered, glued, or welded to the crank cheek 1.

However, it is also possible to insert the sleeves 4 into the openings 6 of the crank cheeks 1 by means of a press fit. In this connection, the bearing journals 2 and 3 can be configured conically, on the inside and/or on the outside, and can produce a friction fit with a correspondingly configured counter-surface on the crank cheek 1, after assembly. The sleeves 4 furthermore have the task of forming a ring channel 10 or 9, respectively, in connection with the two crank cheeks 1 and a part of the inside surface of the main bearing journal 2 and the connecting rod bearing journal 3, respectively. Oil channels 7 are disposed in the crank cheeks 1, by way of which the ring channel 10 stands in connection with the ring channel 9. The ring channels 9 and 10, in each instance, stand in connection with the surface of the connecting rod bearing journals 3 and of the main bearing journals 2 by way of a corresponding bore in the main journal bearing 2 and the connecting rod bearing journal 3, so that the bearing surfaces are provided with oil for their lubrication by way of the crankshaft. In the perspective representation of a crankshaft segment according to FIG. 3, the exit openings 8 for the oil are shown at the surfaces of the main bearing journals 2 and the connecting rod bearing journals 3.

### LIST OF REFERENCE SYMBOLS USED

1 crank cheek
2 main bearing journal
3 connecting rod bearing journal
4 sleeve
5 ring groove
6 opening
7 oil channel
8 exit openings
9 ring channel
10 ring channel

1-6. (canceled)

7. Assembled crankshaft composed of multiple crank cheeks, which can be connected with a main bearing journal, on the one hand, and with a connecting rod bearing journal, on the other hand, whereby the main bearing journal and the connecting rod bearing journal contain cavities that reduce the weight, and the crank cheeks for connecting with the main bearing journal, on the one hand, and with the connecting rod bearing journal, on the other hand, are provided with openings for passing an attachment element through the main bearing journals and connecting rod bearing journals, which are configured to be hollow,
wherein
the crank cheeks (1) are provided, on both sides, with a ring groove (5) for accommodating the main bearing journals (2) and the connecting rod bearing journals (3), which are configured in tubular shape, and that the attachment element for attaching the main bearing journals (2) and the connecting rod bearing journals (3) with the crank cheeks (1), in each instance, is a sleeve (4) provided with a differential thread, that stands in connection with the inside thread disposed in the openings (6) of the crank cheeks (1), with a shape fit and with a force fit.

8. Crankshaft according to claim 7,
wherein
the ring grooves (5) disposed on both sides are disposed offset relative to one another.

9. Crankshaft according to claim 7,
wherein
the main bearing journals (2) and the connecting rod bearing journals (3) are connected with the crank cheeks (1) by means of soldering, gluing, welding.

10. Crankshaft according to claim 7,
wherein
the ring channel (9) is delimited by a part of the inside surface of the tubular connecting rod bearing journal (3), a part of the outside surface of the related sleeve (4), and laterally by the related crank cheeks (1), and the ring channel (10) is delimited by a part of the inside surface of the tubular main bearing journal (2), a part of the outside surface of the related sleeve (4), and laterally by the related crank cheeks (1).

11. Crankshaft according to claim 7,
wherein
oil channels (7) are disposed in the crank cheeks (1), which stand in connection with an exit opening (8) on the surfaces of the main bearing journals (2) by way of the ring channel (9), and with an exit opening (8) on the surfaces of the connecting rod bearing journals (3) by way of a ring channel (10).
